(19) United States
(12) Patent Application Publication
(10) Pub. No.: US 2005/0155954 A1
(43) Pub. Date: Jul. 21, 2005

(54) Semiconductor wafer processing method

(75) Inventors: Ryugo Oba, Tokyo (JP); Hitoshi Hoshino, Tokyo (JP); Yukiyasu Masuda, Tokyo (JP)

Correspondence Address: SMITH, GAMBRELL & RUSSELL, LLP, 1850 M STREET, N.W., SUITE 800, WASHINGTON, DC, 20036, US

(73) Assignee: Disco Corporation

(21) Appl. No.: 11/036,334

(22) Filed: Jan. 18, 2005

(30) Foreign Application Priority Data
Jan. 20, 2004 (JP) PAT. 2004 - 12140

(51) Int. Cl. B23K 26/14

(52) U.S. Cl. 219/121.67

(57) ABSTRACT

A semiconductor wafer processing method for dividing a semiconductor wafer comprising semiconductor chips, which are composed of a laminate consisting of an insulating film and a functional film laminated on the front surface of a semiconductor substrate and are sectioned by streets, into individual semiconductor chips by cutting the wafer with a cutting blade along the streets, the method comprising a laser groove forming step for forming laser grooves which reach the semiconductor substrate by applying a pulse laser beam to the streets of the semiconductor wafer; and a cutting step for cutting the semiconductor substrate with the cutting blade along the laser grooves formed in the streets of the semiconductor wafer, wherein in the laser groove forming step, spots of the pulse laser beam applied to the streets are shaped into rectangular spots by a mask member and the processing conditions are set to satisfy L>(V/Y) (in which Y (Hz) is a repetition-frequency of the pulse laser beam, V (mm/sec) is a processing-feed rate (relative moving speed of the wafer to the pulse laser beam), and L is a length in the processing-feed direction of the spot of the pulse laser beam).

### FIELD OF THE INVENTION

The present invention relates to a semiconductor wafer processing method for dividing a semiconductor wafer along streets, the semiconductor wafer comprising semiconductor chips which are composed of a laminate consisting of an insulating film and a functional film formed on the front surface of a semiconductor substrate such as a silicon substrate or the like and, which are sectioned by the streets.

### DESCRIPTION OF THE PRIOR ART

As is known to people of ordinary skill in the art, in the production process of a semiconductor device, there is formed a semiconductor wafer comprising a plurality of semiconductor chips such as IC's or LSI's which are composed of a laminate consisting of an insulating film and a functional film and formed in a matrix on the front surface of a semiconductor substrate such as a silicon substrate. In this semiconductor wafer thus formed, the above semiconductor chips are sectioned by lines called “streets”, and individual semiconductor chips are produced by cutting the semiconductor wafer along the streets. Cutting along the streets of the semiconductor wafer is generally carried out by a cutting machine called “dicer”. This cutting machine comprises a chuck table for holding a semiconductor wafer as a workpiece, a cutting means for cutting the semiconductor wafer held on the chuck table, and a moving means for moving the chuck table and the cutting means relative to each other. The cutting means has a rotary spindle that is rotated at a high speed and a cutting blade mounted to the spindle. The cutting blade comprises a disk-like base and an annular cutting edge that is mounted onto the side wall peripheral portion of the base and formed as thick as about 20 μm by fixing diamond abrasive grains having a diameter of about 3 μm to the base by electroforming.

To improve the throughput of a semiconductor chip such as IC or LSI, a semiconductor wafer comprising semiconductor chips which are composed of a laminate consisting of a low-dielectric insulating film (Low-k film) formed of a film of an inorganic material such as SiOF or BSG (SiOB) or a film of an organic material such as a polyimide-based or parylene-based polymer and a functional film forming circuits on the front surface of a semiconductor substrate such as a silicon substrate has been implemented nowadays.

When the above semiconductor wafer having a Low-k film laminated thereon is cut along the streets with a cutting blade, a problem arises in that as the Low-k film is extremely fragile like mica, the Low-k film peels off, and this peeling reaches the circuits and causes a fatal damage to the semiconductor chips. Further, even in a semiconductor wafer having no Low-k film, when the film formed on the front surface of the semiconductor substrate is cut along the streets with a cutting blade, a problem arises in that it peels off by destructive force generated by the cutting operation of the cutting blade, thereby damaging the semiconductor chips.

To solve the above problems, JP-A 2003-320466, for example, discloses a processing method in which a laser beam is applied along the streets of a semiconductor wafer to remove a laminate comprising a Low-k film that forms the streets, and then, a cutting blade is positioned to the area from which the laminate has been removed, to cut the semiconductor wafer.

In the step of removing the laminate in the above processing method disclosed by the above publication, in order to remove the laminate without fail, a pulse laser beam is applied such that the spots “S” of the pulse laser beam overlap with one another as shown in FIG. 14. Since the spots “S” of the laser beam applied are of a circular shape, triangular acute-angled portions “T” are formed on the outsides of the overlapped portions of the beam spots “S”, and a new problem occurred in that the laminate peels off from the acute-angled portions “T”.

### SUMMARY OF THE INVENTION

It is an object of the present invention to provide a semiconductor wafer processing method, which can divide a semiconductor wafer along streets, the semiconductor wafer comprising semiconductor chips, which are composed of a laminate consisting of an insulating film and a functional film laminated on the front surface of a semiconductor substrate and are sectioned by streets, into individual semiconductor chips without causing peeling off of the laminate.

To attain the above object, according to the present invention, there is provided a semiconductor wafer processing method for dividing a semiconductor wafer comprising semiconductor chips, which are composed of a laminate consisting of an insulating film and a functional film formed on the front surface of a semiconductor substrate and are sectioned by streets, into individual semiconductor chips by cutting the wafer with a cutting blade along the streets, the method comprising:
a laser groove forming step for forming laser grooves which reach the semiconductor substrate by applying a pulse laser beam in the range of a width wider than the width of the cutting blade and not larger than the width of the streets, to the streets of the semiconductor wafer; and
a cutting step for cutting the semiconductor substrate with the cutting blade along the laser grooves formed in the streets of the semiconductor wafer, wherein
in the laser groove forming step, spots of the pulse laser beam applied to the streets are shaped into rectangular spots by a mask member and the processing conditions are set to satisfy L>(V/Y) (in which Y (Hz) is a repetition frequency of the pulse laser beam, V (mm/sec) is a processing-feed rate (relative moving speed of the wafer to the pulse laser beam), and L is a length in the processing-feed direction of the spot of the pulse laser beam).

According to the present invention, since the spots of the pulse laser beam applied to the streets of the semiconductor wafer are shaped into rectangular spots by the mask member and adjacent beam spots partially overlap with one another in the processing-feed direction, the triangular acute-angled portions are not formed on the outsides of the overlapped portions of the beam spots, unlike circular beam spots, and the problem that the laminate 21 peels off from the acute-angled portions is eliminated.

### BRIEF DESCRIPTION OF THE DRAWINGS

FIG. 1 is a perspective view showing a state where a semiconductor wafer to be divided by the semiconductor wafer processing method of the present invention is mounted on a frame by a protective tape;

FIG. 2 is a sectional enlarged view of the semiconductor wafer shown in FIG. 1;

FIG. 3 is a perspective view of the principal section of a laser beam machine for carrying out the laser groove forming step in the semiconductor wafer processing method of the present invention;

FIG. 4 is a block diagram schematically showing the constitution of laser beam application means provided in the laser beam machine shown in FIG. 3;

FIG. 5 is a plan view of a mask member provided in the laser beam application means shown in FIG. 4;

FIG. 6. is a diagram showing the shape of the spot of a pulse laser beam applied through the mask member shown in FIG. 5;

FIGS. 7(a) and 7(b) are diagrams for explaining the laser groove forming step in the semiconductor wafer processing method of the present invention;

FIG. 8 is a diagram showing a state where adjacent spots of the pulse laser beam applied in the laser groove forming step shown in FIGS. 7(a) and 7(b) overlap with one another;

FIG. 9 is a diagram showing laser grooves formed in the semiconductor wafer by the laser groove forming step in the semiconductor wafer processing method of the present invention;

FIG. 10 is a diagram showing another example of laser grooves formed in the semiconductor wafer by the laser groove forming step in the semiconductor wafer processing method of the present invention;

FIG. 11 is a perspective view of the principal section of a cutting machine for carrying out the cutting step in the semiconductor wafer processing method of the present invention;

FIGS. 12(a) and 12(b) are diagrams for explaining the cutting step in the semiconductor wafer processing method of the present invention;

FIGS. 13(a) and 13(b) are diagrams showing a state where the semiconductor wafer is cut along the laser grooves by the cutting step in the semiconductor processing method of the present invention; and

FIG. 14 is a diagram showing a state where adjacent spots of a pulse laser beam applied by laser beam application means of the prior art overlap with one another.

### DETAILED DESCRIPTION OF THE PREFERRED EMBODIMENTS

The semiconductor wafer processing method of the present invention will be described in detail hereinunder with reference to the accompanying drawings.

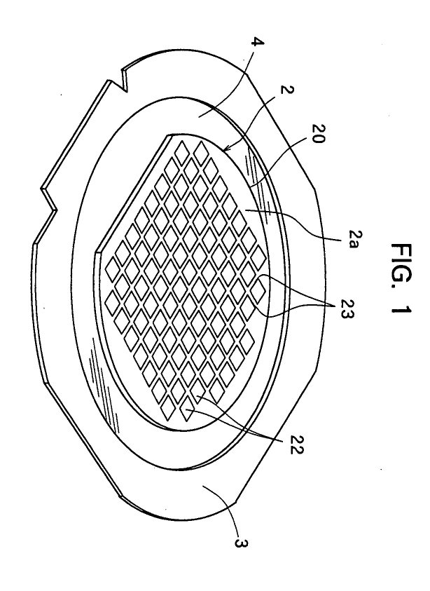

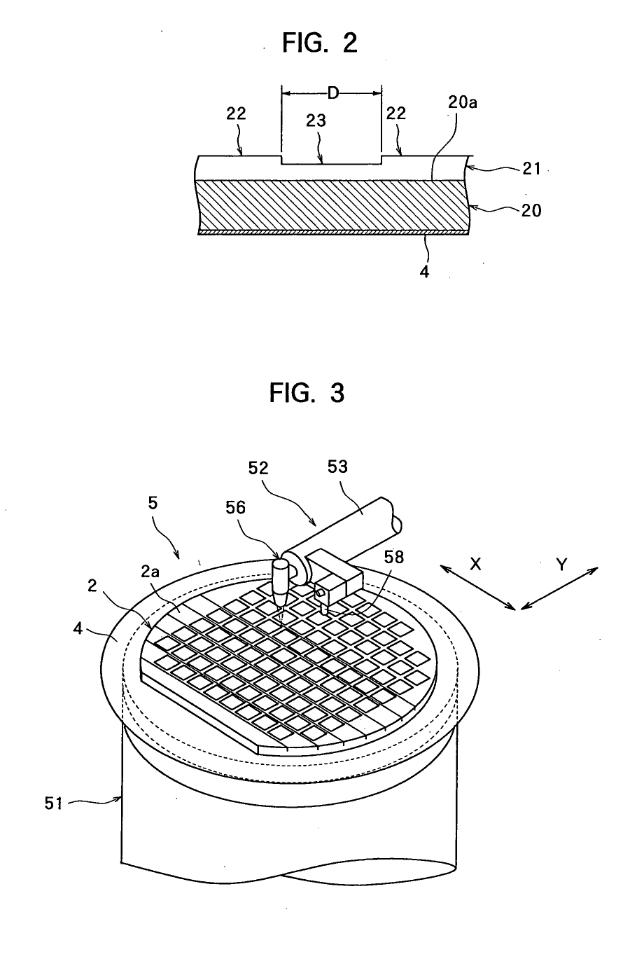

FIG. 1 is a perspective view of a semiconductor wafer to be divided according to the processing method of the present invention and FIG. 2 is an enlarged sectional view of the principal section of the semiconductor wafer shown in FIG. 1. In the semiconductor wafer 2 shown in FIG. 1 and FIG. 2, a plurality of semiconductor chips 22 such as IC's or LSI's composed of a laminate 21 consisting of an insulating film and a functional film forming circuits are formed in a matrix on the front surface 20a of a semiconductor substrate 20 such as a silicon substrate, as shown in FIG. 2. The semiconductor chips 22 are sectioned by streets 23 having a width D and formed in a lattice pattern. In the illustrated embodiment, the insulating film forming the laminate 21 is a low-dielectric insulating film (Low-k film) formed of a film of an inorganic material such as SiOF or BSG (SiOB) or a film of an organic material such as a polyimide-based or parylene-based polymer. The back surface of the semiconductor wafer 2 thus formed is put to a protective tape 4 affixed to an annular frame 3 as shown in FIG. 1 so that when it is divided into individual semiconductor chips, the semiconductor chips 22 do not fall apart.

In the method of processing the semiconductor wafer 2 according to the present invention, the step of forming laser grooves which reach the semiconductor substrate 20 by applying a pulse laser beam along the streets 23 formed on the semiconductor wafer 2 in a range of a width larger than the width of a cutting blade, which will be described later, and not larger than the width D of the street 20 is first carried out. This laser groove forming step is carried out with a laser beam machine shown in FIGS. 3 to 5. The laser beam machine 5 shown in FIGS. 3 to 5 has a chuck table 51 for holding a workpiece, a laser beam application means 52 for applying a laser beam to the workpiece held on the chuck table 51 and an image pick-up means 58 for picking up an image of the workpiece held on the chuck table 51. The chuck table 51 is so constituted as to suction-hold the workpiece and is moved by a moving mechanism (not shown) in a processing-feed direction indicated by an arrow X and an indexing-feed direction indicated by an arrow Y in FIG. 3.

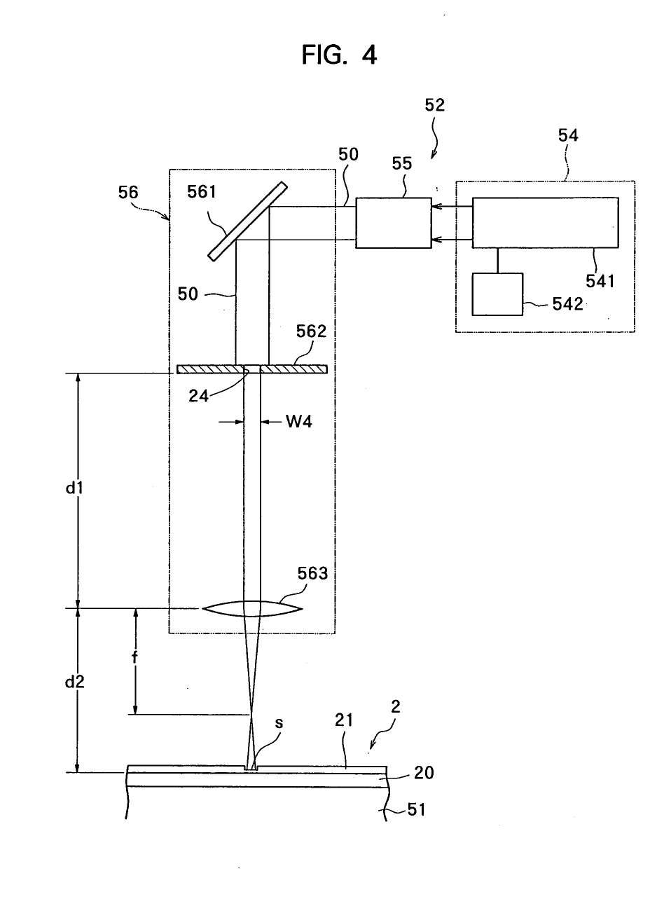

The above laser beam application means 52 has a cylindrical casing 53 arranged substantially horizontally. In the casing 53, there are installed a pulse laser beam oscillation means 54 and a transmission optical system 55 as shown in FIG. 4. The pulse laser beam oscillation means 54 is constituted by a pulse laser beam oscillator 541 composed of a YAG laser oscillator or YVO4 laser oscillator and repetition frequency setting means 542 connected to the pulse laser beam oscillator 541. The transmission optical system 55 comprises suitable optical elements such as a beam splitter, etc.

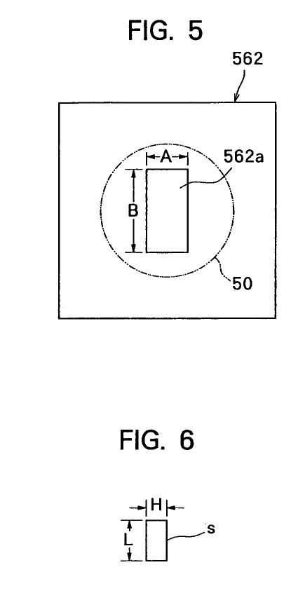

A condenser 56 is attached to the end of the above casing 53. The condenser 56 comprises a deflection mirror 561, a mask member 562 and an objective condenser lens 563 as shown in FIG. 4. The deflection mirror 561 deflects a pulse laser beam 50 applied from the above pulse laser beam oscillation means 54 through the transmission optical system 55 at a right angle toward the above mask member 562. The mask member 562 has a rectangular opening 562a having a width A and a length B, as shown in FIG. 5. The opening 562a of the mask member 562 is smaller than the circular cross-section (shown by a two-dot chain line in FIG. 5) of the pulse laser beam 50 before it is shaped. After the pulse laser beam 50 passes through the opening 562a of the mask member, its section is shaped into a rectangular form in accordance with the opening 562a and then it passes through the objective condenser lens 563 to be applied to the semiconductor wafer 2 as a beam spot similar in shape to the opening 562a of the mask member 562. In other words, an image of the opening 562a of the mask member 562 is formed on the semiconductor wafer 2. That is, the pulse laser beam 50 is applied to the semiconductor wafer 2 as a rectangular beam spot “s” shown in FIG. 6. The interval between the mask member 562 and the objective condenser lens 563 is set to d1, the interval between the objective condenser lens 563 and the semiconductor wafer 2 is set to d2, and the interval d2 is larger than the focusing distance “f” of the objective condenser lens 563 and satisfies d2=(d1×f)/(d1−f). The size of the rectangular beam spot “s” based on the size of the opening 562a of the mask member 562 can be obtained from d2/d1 or f/(d1−f) by maintaining the relation of d2/d1 =f/(d1−f). Therefore, when the opening 562a of the above mask member 562 has a width A of 400 μm and a length B of 800 μm and the ratio (d2/d1) of the interval d1 between the mask member 562 and the objective condenser lens 563 to the interval d2 between the objective condenser lens 563 and the semiconductor wafer 2 is 1/20 (d2/d1=1/20), the rectangular spot “s” of the pulse laser beam 50 has a width H of 20 μm and a length L of 40 μm. In other words, to obtain a beam spot “s” having a width H of 20 μm and a length L of 40 μm, when the above (d2/d1) is set to 1/20, the opening 562a of the mask member 562 must have a width A of 400 μm and a length B of 800 μm. To obtain a square beam spot “s” having a width H of 20 μm and a length L of 20 μm, when the above (d2/d1) is set to 1/20, the opening 562a of the mask member 562 must have a width A of 400 μm and a length B of 400 μm.

The image pick-up means 58 mounted to the end of the casing 53 constituting the above laser beam application means 52 is constituted by an ordinary image pick-up device (CCD) and the like for picking up an image with visible radiation in the illustrated embodiment, and sends an image signal to a control means that is not shown.

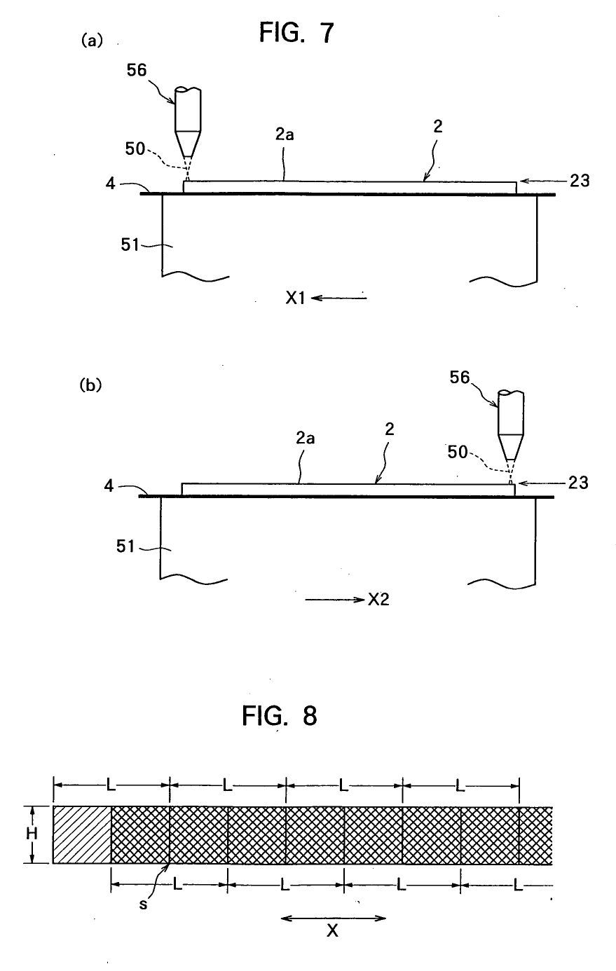

The laser groove forming step which is carried out with the above laser beam machine 5 will be described with reference to FIG. 3, FIGS. 7(a) and 7(b) to FIG. 10.

In this laser groove forming step, the semiconductor wafer 2 is first placed on the chuck table 51 of the laser beam machine 5 shown in FIG. 3 in such a manner that the front surface 2a (the surface side on which the laminate 21 is formed) faces up and suction-held on the chuck table 51. In FIG. 3, the annular frame 3 having the protective tape 4 affixed thereto is omitted, and the annular frame 3 is held by a suitable frame holding means provided on the chuck table 51.

The chuck table 51 suction-holding the semiconductor wafer 2 as described above is positioned right below the image pick-up means 58 by a moving mechanism that is not shown. After the chuck table 51 is positioned right below the image pick-up means 58, alignment work for detecting the processing area to be processed of the semiconductor wafer 2 is carried out by the image pick-up means 58 and the control means that is not shown. That is, the image pick-up means 58 and the control means (not shown) carry out image processing such as pattern matching and so on to align a street 23 formed in a predetermined direction of the semiconductor wafer 2 with the condenser 56 of the laser beam application means 52 for applying a laser beam along the street 23, thereby performing the alignment of a laser beam application position. The alignment of the laser beam application position is also carried out on streets 23 that are formed on the semiconductor wafer 2 and extend in a direction perpendicular to the above predetermined direction.

After the street 23 formed on the semiconductor wafer 2 held on the chuck table 51 is detected and the alignment of the laser beam application position is carried out as described above, the chuck table 51 is moved to a laser beam application area where the condenser 56 of the laser beam application means 52 for applying a laser beam is located as shown in FIG. 7(a) to bring one end (left end in FIG. 7(a)) of the predetermined street 23 to a position right below the condenser 56 of the laser beam application means 52. The chuck table 51, that is, the semiconductor wafer 2 is moved in the direction indicated by the arrow X1 in FIG. 7(a) at a predetermined processing-feed rate while a pulse laser beam 50 is applied from the condenser 56. When the application position of the condenser 56 of the laser beam application means 52 reaches the other end (right end in FIG. 7(b)) of the street 23 as shown in FIG. 7(b), the application of the pulse laser beam 50 is suspended and the movement of the chuck table 51, that is, the semiconductor wafer 2 is stopped.

Thereafter, the chuck table 51, that is, the semiconductor wafer 2 is moved about 15 μm in a direction (indexing-feed direction) perpendicular to the sheet. The chuck table 51, that is, the semiconductor wafer 2 is then moved in the direction indicated by the arrow X2 in FIG. 7(b) at a predetermined processing-feed rate while the pulse laser beam 50 is applied from the laser beam application means 52. When the application position of the laser beam application means 52 reaches the position shown in FIG. 7(a), the application of the pulse laser beam 50 is suspended and the movement of the chuck table 51, that is, the semiconductor wafer 2 is stopped.

After the pulse laser beam 50 applied from the laser beam application means 52 passes through the opening 562a of the mask member 562 as described above, it is shaped into a rectangular beam and applied to the semiconductor wafer 2 as a rectangular beam spot “s”. When the processing conditions are set to satisfy L>(V/Y) (in which Y (Hz) is the repetition frequency of the pulse laser beam, V (mm/sec) is the processing-feed rate (relative moving speed of the wafer to the pulse laser beam), and L is the length in the processing-feed direction of the spot “s” of the pulse laser beam), adjacent spots ¢s” of the pulse laser beam partially overlap with one another in the processing-feed direction X, that is, along the street 23, as shown in FIG. 8. In the example shown in FIG. 8, the overlapping ratio of the spots “s” of the pulse laser beam in the processing-feed direction X is 50%. This overlapping ratio can be suitably set by changing the processing-feed rate V (mm/sec) or the length L in the processing-feed direction of the spot “s” of the pulse laser beam.

The above laser groove forming step is carried out under the following processing conditions, for example.
Light source of laser beam: YVO4 laser or YAG laser
Wavelength: 355 nm
Output: 1.0 to 2.0 W
Repetition frequency: 50 kHz
Pulse width: 10 ns
Output: 0.5 W
Size of beam spot “s”: 20 μm in height×40 μm in length, 20 μm in height×20 μm in length
Processing-feed rate: 50 to 500 mm/sec

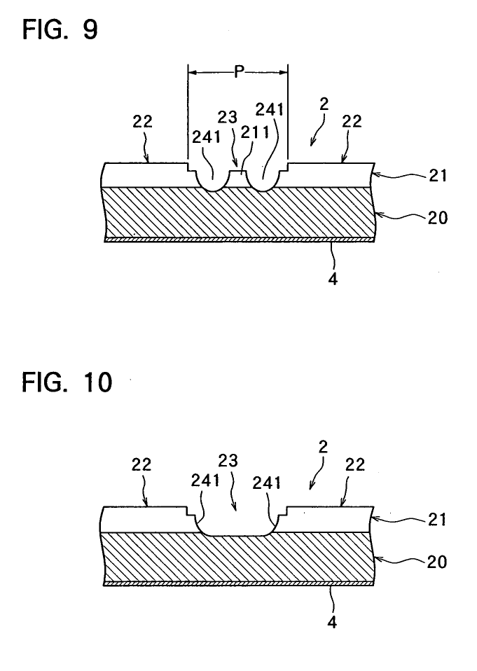

A pair of laser grooves 241 and 241 which reach the semiconductor substrate 20 are formed in a range not wider than the width D of the street 23 of the laminate 21 forming the street 23 of the semiconductor wafer 2 along the street 23 at a wider interval than the width of the cutting blade which will be described later, as shown in FIG. 9 by carrying out the above laser groove forming step. Since the laser grooves 241 and 241 thus formed in the laminate 21 forming the street 23 of the semiconductor wafer 2 reach the semiconductor substrate 20, the laminate 21 forming the street 23 is completely separate from the semiconductor chips 22 side. In this illustrated embodiment, part 211 of the laminate 21 remains between the pair of laser grooves 241 and 241 at the center portion of the street 23. According to the present invention, since the pulse laser beam is shaped into a rectangular beam and applied such that adjacent beam spots “s” partially overlap with one another in the processing-feed direction to form the laser grooves 241 and 241, the triangular acute-angled portions “T” are not formed on the outsides of the overlapped portions, unlike the circular beam spots “S” shown in FIG. 14, and the problem that the laminate 21 peels off from the acute-angled portions “T” is eliminated.

In the embodiment shown in FIG. 9, part 211 of the laminate 21 remains between the pair of laser grooves 241 and 241 at the center portion of the street 23 of the semiconductor wafer 2 in a state after the laser groove forming step. By applying a pulse laser beam to the remaining part 211 of the laminate 21, however, the remaining part 211 of the laminate 21 can be removed as shown in FIG. 10.

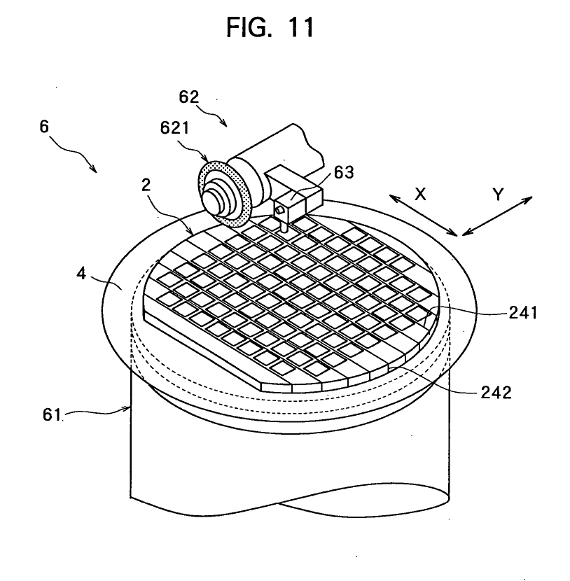

After the above-described laser groove forming step is carried out on all the streets 23 formed on the semiconductor wafer 2, the cutting step for cutting the semiconductor wafer 2 along the streets 23 is carried out. In this cutting step, a cutting machine 6 which is generally used as a dicing machine as shown in FIG. 11 may be used. That is, the cutting machine 6 comprises a chuck table 61 having a suction-holding means, a cutting means 62 having a cutting blade 621, and an image pick-up means 63 for picking up an image of the workpiece held on the chuck table 61.

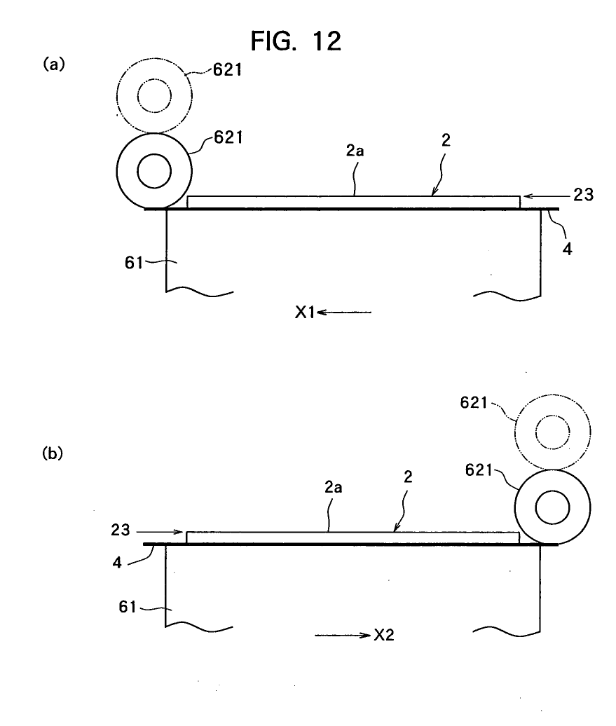

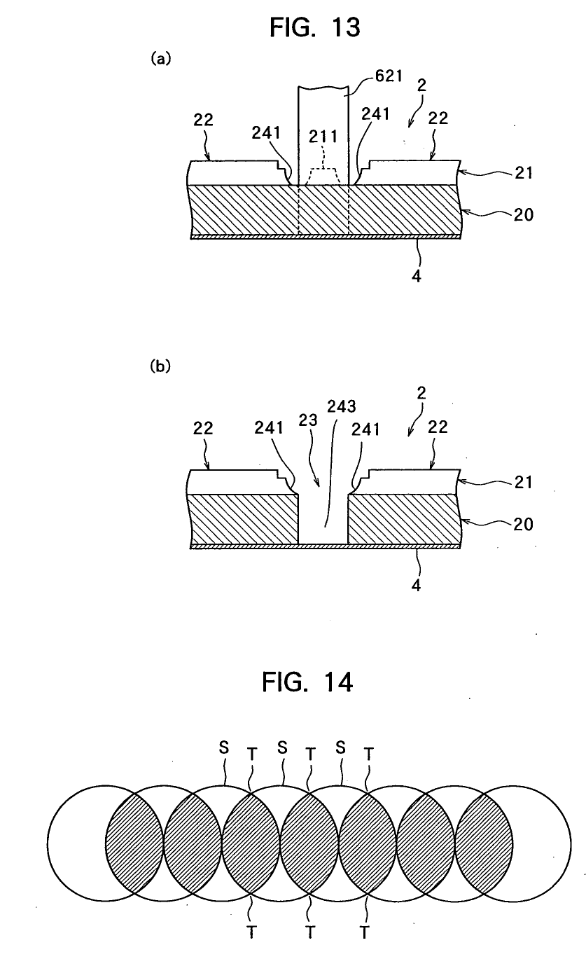

The cutting step to be carried out with the above cutting machine 6 will be described with reference to FIG. 11, FIGS. 12(a) and 12(b), and FIGS. 13(a) and 13(b).

That is, as shown in FIG. 11, the semiconductor wafer 2 that has been subjected to the above-described laser groove forming step is placed on the chuck table 61 of the cutting machine 6 in such a manner that the: front surface 2a of the semiconductor wafer 2 faces up and held on the chuck table 61 by a suction means that is not shown. The chuck table 61 suction-holding the semiconductor wafer 2 is positioned right below the image pick-up means 63 by a moving mechanism that is not shown.

After the chuck table 61 is positioned right below the image pick-up means 63, alignment work for detecting the area to be cut of the semiconductor wafer 2 is carried out by the image pick-up means 63 and a control means that is not shown. That is, the image pick-up means 63 and the control means (not shown) carry out image processing such as pattern matching, etc. to align a street 23 formed in a predetermined direction of the semiconductor wafer 2 with the cutting blade 621 for cutting along the street 23, thereby performing the alignment of the area to be cut. The alignment of the area to be cut is also carried out on streets 23 that are formed on the semiconductor wafer 2 and extend in a direction perpendicular to the above predetermined direction.

After the street 23 formed on the semiconductor wafer 2 held on the chuck table 61 is detected and the alignment of the area to be cut is carried out as described above, the chuck table 61 holding the semiconductor wafer 2 is moved to the cutting start position of the area to be cut. At this point, as shown in FIG. 12(a), the semiconductor wafer 2 is brought to a position where one end (left end in FIG. 12(a)) of the street 23 to be cut is located on the right side by a predetermined distance from just below the cutting blade 621. The semiconductor wafer 2 is also positioned such that the cutting blade 621 is located in the center between the pair of laser grooves 241 and 241 formed in the street 23.

After the chuck table 61, that is, the semiconductor wafer 2 is thus brought to the cutting start position of the area to be cut, the cutting blade 621 is moved down from its standby position shown by a two-dot chain line in FIG. 12(a) to a predetermined cutting position shown by a solid line in FIG. 12(a). This cutting position is set to a position where the lower end of the cutting blade 621 reaches the protective tape 4 affixed to the back surface of the semiconductor wafer 2, as shown in FIG. 13(a).

Thereafter, the cutting blade 621 is rotated at a predetermined revolution and the chuck table 61, that is, the semiconductor wafer 2 is moved in the direction indicated by the arrow X1 in FIG. 12(a) at a predetermined cutting-feed rate. When the chuck table 61, that is, the semiconductor wafer 2 reaches a position where the other end (right end in FIG. 12(b)) of the street 23 is located on the left side by a predetermined distance from just below the cutting blade 621 as shown in FIG. 12(b), the movement of the chuck table 61, that is, the semiconductor wafer 2 is stopped. By thus moving the chuck table 61, that is, the semiconductor wafer 2, a cut groove 243 which reaches the back surface is formed between the laser grooves 241 and 241 formed in the street 23 of the semiconductor wafer 2, as shown in FIG. 13(b). When the area between the pair of laser grooves 241 and 241 is cut with the cutting blade 621 as described above, part 211 of the laminate 21 remaining between the laser grooves 241 and 241 is cut away with the cutting blade 621. As the part 211 is separate from the semiconductor chips 22 by the laser grooves 241 and 241 on both sides, even when it is peeled off, it does not affect the semiconductor chips 22. When the remaining part 211 of the laminate 21 forming the street 23 has been removed by the groove forming step as shown in FIG. 10, only the semiconductor substrate 20 is cut with the cutting blade 621 in the cutting step.

The above cutting step is carried out under the following processing conditions, for example.
Cutting blade: outer diameter of 52 mm, thickness of 20 μm
Revolution of cutting blade: 30,000 rpm
Cutting-feed speed: 50 mm/sec

Thereafter, the cutting blade 621 is moved up to the stand by position shown by the two-dot chain line in FIG. 12(b), and the chuck table 61, that is, the semiconductor wafer 2 is moved in the direction indicated by the arrow X2 in FIG. 12(b) to return to the position shown in FIG. 12(a). The chuck table 61, that is, the semiconductor wafer 2 is indexing-fed by a distance corresponding to the interval between the streets 23 in a direction (indexing-feed direction) perpendicular to the sheet to bring a street 23 to be cut next to a position corresponding to the cutting blade 621. After the street 23 to be cut next is located at a position corresponding to the cutting blade 621, the above-mentioned cutting step is carried out.

The above cutting step is carried out on all the streets 23 formed on the semiconductor wafer 2. As a result, the semiconductor wafer 2 is cut along the laser grooves 241 formed in the streets 23 to be divided into individual semiconductor chips 20.

1. A semiconductor wafer processing method for dividing a semiconductor wafer comprising semiconductor chips, which are composed of a laminate consisting of an insulating film and a functional film laminated on the front surface of a semiconductor substrate and are sectioned by streets, into individual semiconductor chips by cutting the wafer with a cutting blade along the streets, the method comprising:
a laser groove forming step for forming laser grooves which reach the semiconductor substrate by applying a pulse laser beam in the range of a width wider than the width of the cutting blade and not larger than the width of the streets, to the streets of the semiconductor wafer; and
a cutting step for cutting the semiconductor substrate with the cutting blade along the laser grooves formed in the streets of the semiconductor wafer, wherein
in the laser groove forming step, spots of the pulse laser beam applied to the streets are shaped into rectangular spots by a mask member and the processing conditions are set to satisfy L>(V/Y) (in which Y (Hz) is a repetition frequency of the pulse laser beam, V (mm/sec) is a processing-feed rate (relative moving speed of the wafer to the pulse laser beam), and L is a length in the processing-feed direction of the spot of the pulse laser beam).
